(19) United States
(12) Patent Application Publication
(10) Pub. No.: US 2015/0286019 A1
(43) Pub. Date: Oct. 8, 2015

(54) OPTICAL TRANSCEIVER HAVING MULTIPLE OPTICAL PATH

(71) Applicant: W-Optic Technology Inc., Taoyuan (TW)

(72) Inventors: Chien Ting LIN, Taoyuan (TW); Chun Ching HUANG, Taoyuan (TW); Tso Han CHIEN, Taoyuan (TW)

(21) Appl. No.: 14/625,856

(22) Filed: Feb. 19, 2015

(30) Foreign Application Priority Data
Apr. 7, 2014 (TW) 103205896

(51) Int. Cl. G02B 6/42; H04B 10/40

(52) U.S. Cl. CPC G02B 6/4246; H04B 10/40; G02B 6/4215

(57) ABSTRACT

An optical transceiver includes an electrical terminal, an optical connector, an electrical subassembly connected to the electrical terminal, and an optical subassembly connected between the electrical subassembly and the optical connector, the optical subassembly includes an optical coupler, two filters aligned with the optical coupler, and an optical emitting/receiving combination, the optical emitting/receiving combination includes an optical emitter aligned with the optical coupler and the filters, and two elements aligned with the filters respectively. The elements are selected from optical detectors or optical emitters aligned with the filters respectively.

### BACKGROUND OF THE INVENTION

1. Field of the Invention

The present invention relates to an optical transceiver, and more particularly to an optical transceiver including an optical subassembly (OSA) having multiple optical paths for facilitating the operating function of the optical transceiver and for reducing the making or manufacturing procedures and cost.

2. Description of the Prior Art

Typical optical transceivers, such as small form-factor pluggable (SFP) optical transceiver, SFP+, 10 gigabit small form-factor pluggable (XFP) optical transceiver, quad small form-factor pluggable (QSFP) optical transceiver, etc., have been widely used in optical and internet communicating technologies for transmitting and/or receiving signals.

For example, as shown in FIG. 1, the optical transceiver 10 comprises an electrical plug or electrode or terminal 11, one or more (such as two) optical connectors 12, and an electrical subassembly 13 and one or more (such as two) optical subassemblies 20 connected or coupled between the electrical terminal 11 and the optical connectors 12, in which the electrical subassembly 13 is electrically connected or coupled to or between the electrical terminal 11 and the optical subassemblies 20, and the optical subassemblies 20 are electrically connected or coupled to or between the electrical subassembly 13 and the optical connectors 12.

The optical connectors 12 are arranged and provided for connecting or coupling to various optical couplers or sockets, such as SC, LC, or MU optical couplers or sockets, and the electrical subassembly 13 may be selected from laser driving electric circuits or pre-located amplifying circuits (emitting), or the other amplifying circuits (receiving), and the optical transceiver 10 is provided for converting the electrical signals and the optical signals and for allowing the electrical signals and the optical signals to be communicated between two different stations or locations or the like.

As shown in FIG. 2, the small form-factor pluggable (SFP) optical transceiver includes a single emitting, or a single receiving, or includes a single emitting and a single receiving, for example, as shown in FIG. 2, illustrated is a typical optical subassembly 20 including an optical (fiber) coupler 21, an optical emitter 22, such as a laser diode, an optical detector 23, such as a photo diode, and a filter 24 arranged or disposed between the optical coupler 21 and the optical emitter 22 for filtering or reflecting various optical signals of different wave lengths, for example, the optical emitter 22 may transmit or emit an optical signal of a wave length λ1 to the optical coupler 21, and the optical detector 23 may receive another optical signal of a different wave length λ2 from the optical coupler 21.

However, the typical optical transceivers comprise a single emitting and a single receiving only, such that the electrical signals and the optical signals communicated between the two different stations or locations are limited.

The present invention has arisen to mitigate and/or obviate the afore-described disadvantages of the conventional optical transceivers.

### SUMMARY OF THE INVENTION

The primary objective of the present invention is to provide an optical transceiver including an optical subassembly having multiple optical paths for facilitating the operating function of the optical transceiver and for reducing the making or manufacturing procedures and cost.

In accordance with one aspect of the invention, there is provided an optical transceiver comprising an electrical terminal, an optical connector, an electrical subassembly connected to the electrical terminal, and an optical subassembly connected between the electrical subassembly and the optical connector, the optical subassembly including an optical coupler, a first filter and a second filter aligned with the optical coupler, and an optical emitting/receiving combination, the optical emitting/receiving combination including an optical emitter aligned with the optical coupler and the first and the second filters, and a first element and a second element aligned with the first and the second filters respectively for transmitting and/or receiving signals of different wave lengths or having different or multiple optical paths for facilitating the operating function of the optical transceiver and for reducing the making or manufacturing procedures and cost.

The first element of the optical emitting/receiving combination may be selected from an optical detector or an optical emitter aligned with the first filter. The second element of the optical emitting/receiving combination may be selected from an optical detector aligned with the second filter.

The optical transceiver may be selected from small form-factor pluggable (SFP), SFP+, 10 gigabit small form-factor pluggable (XFP), or quad small form-factor pluggable (QSFP) optical transceiver.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating a typical optical transceiver;

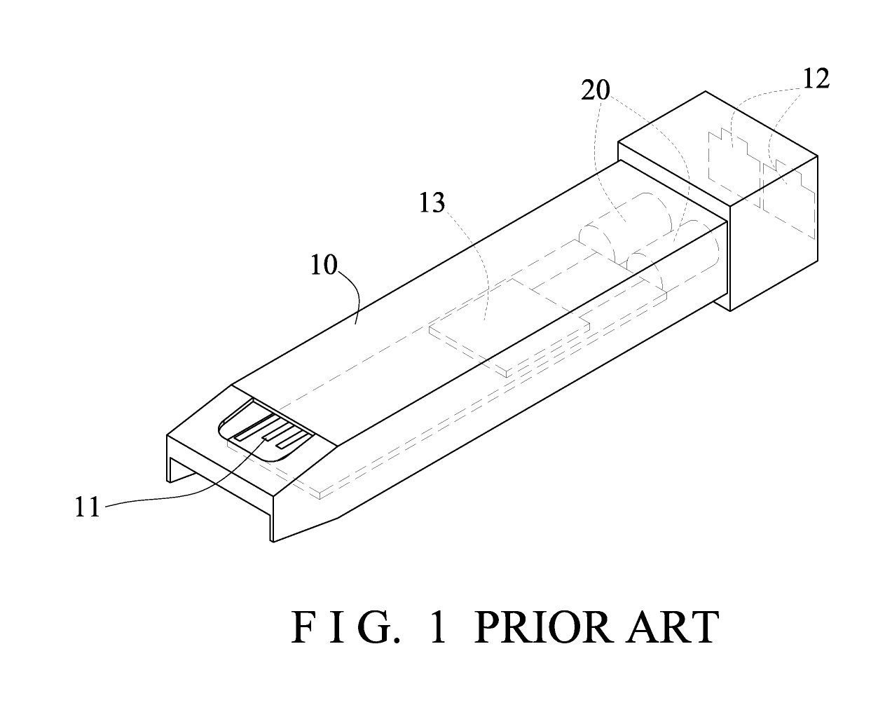

FIG. 2 is a plan schematic view of the typical optical transceiver;

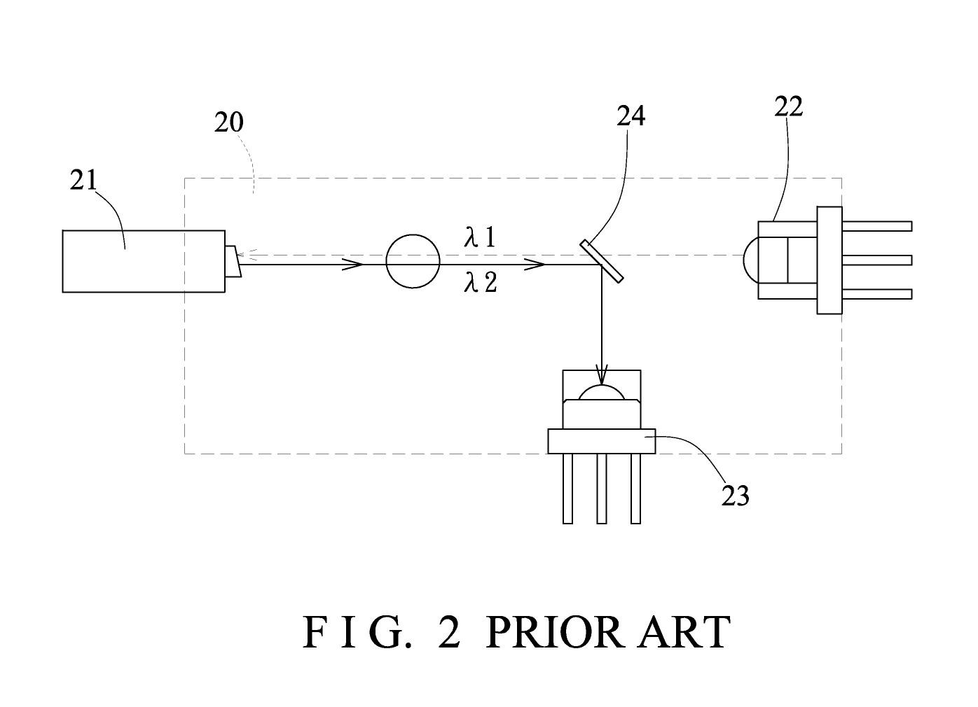

FIG. 3 is a perspective view of an optical transceiver in accordance with the present invention;

FIG. 4 is a plan schematic view of the optical transceiver in accordance with the present invention;

FIG. 5 is another plan schematic view similar to FIG. 4, illustrating the other arrangement of the optical transceiver; and

FIG. 6 is a further plan schematic view similar to FIGS. 4 and 5, illustrating the operation of the optical transceiver.

### DETAILED DESCRIPTION OF THE PREFERRED EMBODIMENT

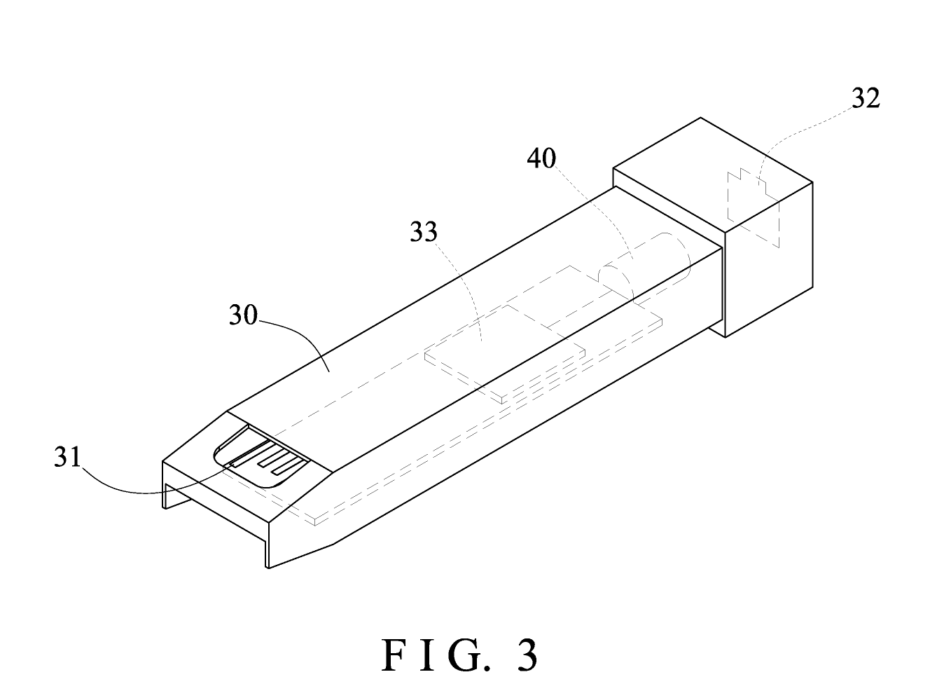

Referring to the drawings, and initially to FIG. 3, an optical transceiver 30 in accordance with the present invention may be selected from small form-factor pluggable (SFP) optical transceiver, SFP+, 10 gigabit small form-factor pluggable (XFP) optical transceiver, quad small form-factor pluggable (QSFP) optical transceiver, etc., and is provided for being used in optical and internet communicating technologies for transmitting and/or receiving signals.

The optical transceiver 30 comprises an electrical plug or electrode or terminal 31, an optical connector 32, and an electrical subassembly 33 and an optical subassembly 40 connected or coupled between the electrical terminal 31 and the optical connector 32, in which the electrical subassembly 33 is electrically connected or coupled to or between the electrical terminal 31 and the optical subassembly 40, and the optical subassembly 40 is electrically connected or coupled to or between the electrical subassembly 33 and the optical connector 32, in which the electrical subassembly 33 is typical and is not related to the present invention and will not be described in further details.

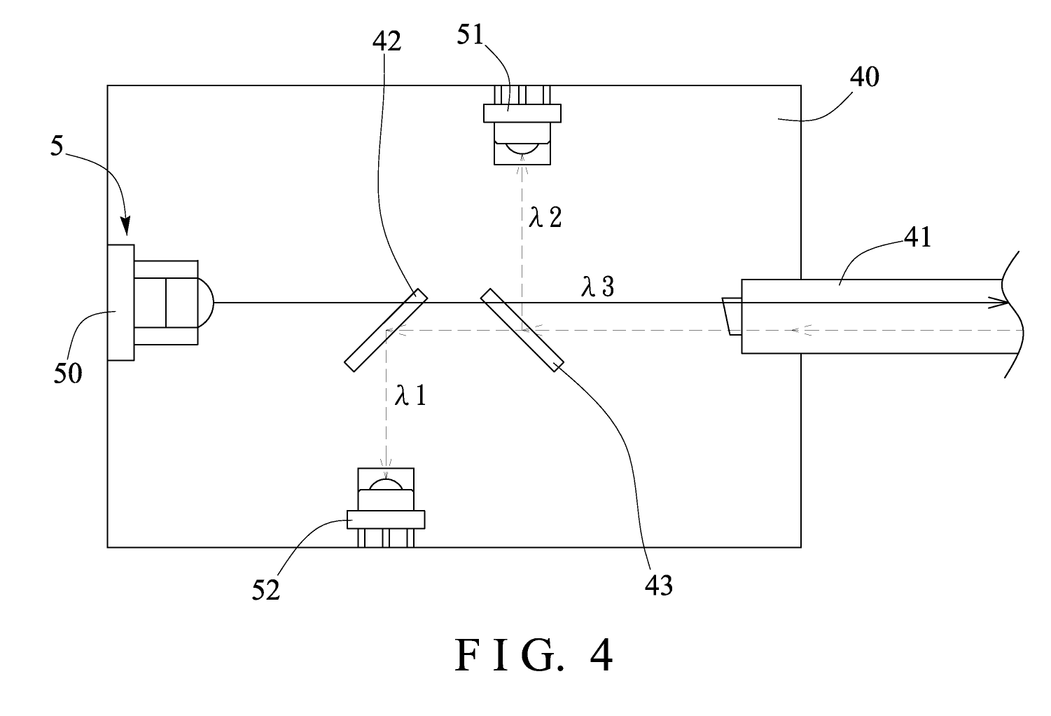

As shown in FIG. 4, the optical subassembly 40 of the optical transceiver 30 includes an optical (fiber) coupler 41, two filters 42, 43 for filtering or reflecting various optical signals of different wave lengths, and an optical emitting/receiving combination 5, in which the optical emitting/receiving combination 5 includes three elements 50, 51, 52: one or more (such as one) optical emitter 50, such as a laser diode, and one or more (such as two) optical receiving elements or detectors 51, 52, such as photo diodes, in which the optical emitter 50 is aligned with the optical coupler 41 and the first and the second filters 42, 43, and/or the filters 42, 43 are arranged or disposed between the optical emitter 50 and the optical coupler 41, for example, the optical emitter 50 may transmit or emit an optical signal of a wave length λ3 to the optical coupler 41, and the optical detectors 51, 52 may receive the optical signals of other or different wave lengths λ1, λ2 from the optical coupler 41.

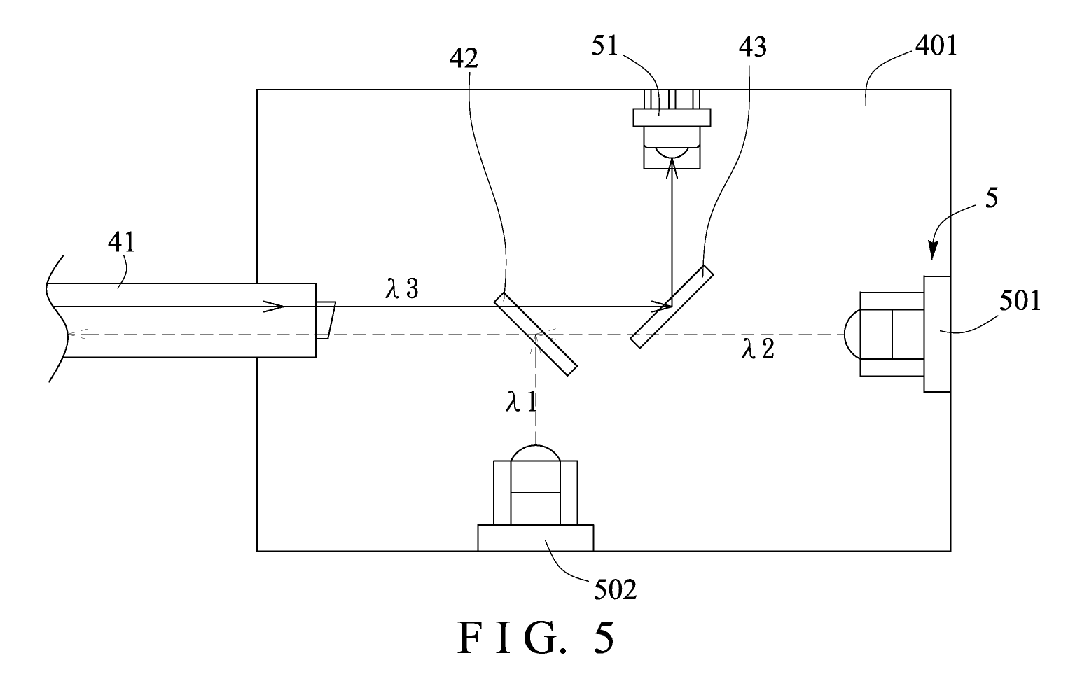

The optical detectors 51, 52 are arranged or disposed or directed toward or aligned with the filters 43, 42 respectively. Alternatively, as shown in FIG. 5, the optical emitting/receiving combination 5 of the optical subassembly 401 may include one or more (such as two) optical emitters 501, 502, and one or more (such as one) optical receiving element or detector 51, such that the optical emitting/receiving combination 5 of the optical subassembly 401 may also include three elements 501, 51, 502 for transmitting and/or receiving signals of different wave lengths or having different or multiple optical paths. The one or first optical emitter 501 is aligned with the optical coupler 41 and the filters 42, 43, and the other or second optical emitter 502 and the optical detector 51 are arranged or disposed or directed toward or aligned with the filters 42, 43 respectively.

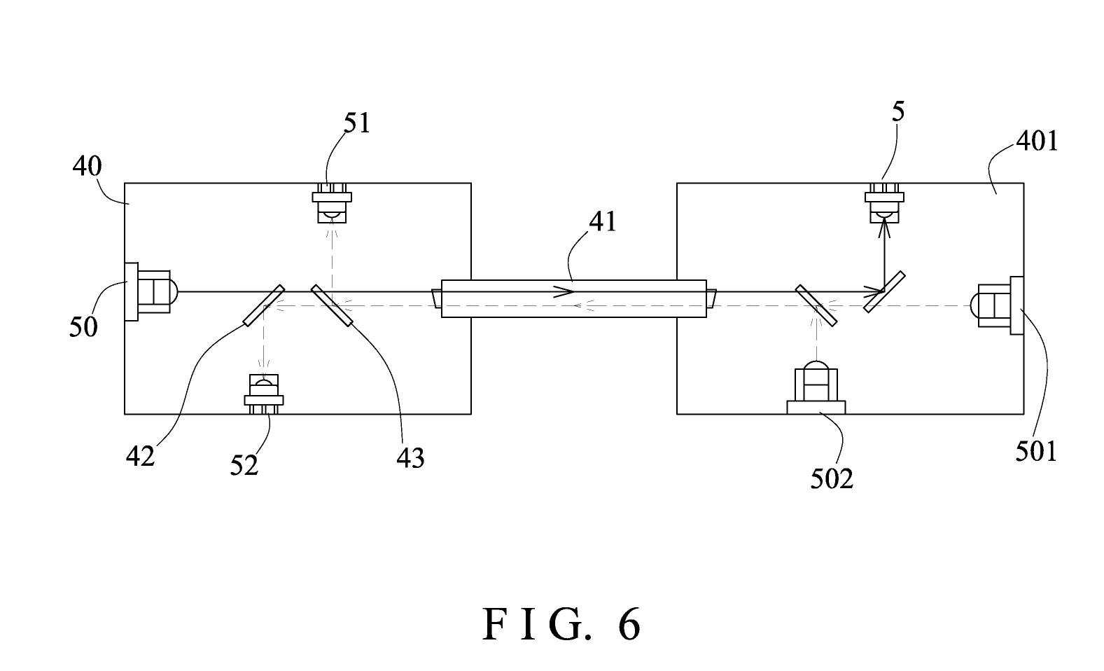

In operation, as shown in FIGS. 4-6, a single optical coupler 41 may be provided and connected or coupled between the optical subassemblies 40, 401 for transmitting and/or receiving signals of different wave lengths, and the optical emitting/receiving combination 5 of the optical subassemblies 40, 401 each may also include three elements 501, 51, 502 for transmitting and/or receiving signals of different wave lengths or having different or multiple optical paths.

Accordingly, the optical transceiver in accordance with the present invention includes an optical subassembly having multiple optical paths for facilitating the operating function of the optical transceiver and for reducing the making or manufacturing procedures and cost.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An optical transceiver comprising:
an electrical terminal,
an optical connector,
an electrical subassembly connected to said electrical terminal, and
an optical subassembly connected between said electrical subassembly and said optical connector, said optical subassembly including an optical coupler, a first filter and a second filter aligned with said optical coupler, and an optical emitting/receiving combination, said optical emitting/receiving combination including an optical emitter aligned with said optical coupler and said first and said second filters, and a first element and a second element aligned with said first and said second filters respectively.

2. The optical transceiver as claimed in claim 1, wherein said first element is selected from an optical detector aligned with said first filter.

3. The optical transceiver as claimed in claim 1, wherein said second element is selected from an optical detector aligned with said second filter.

4. The optical transceiver as claimed in claim 1, wherein said first element is selected from an optical emitter aligned with said first filter.

5. The optical transceiver as claimed in claim 1, wherein said optical transceiver is selected from small form-factor pluggable (SFP), SFP+, 10 gigabit small form-factor pluggable (XFP), or quad small form-factor pluggable (QSFP) optical transceiver.
